(19) United States
(12) Patent Application Publication
(10) Pub. No.: US 2026/0316869 A1
(43) Pub. Date: Oct. 15, 2026

(54) EXTENDABLE REARVIEW MIRROR FOR MOTORCYCLE

(71) Applicant: RIZOMA S.R.L., Ferno (VA) (IT)

(72) Inventor: Fabrizio RIGOLIO, Ferno (VA) (IT)

(73) Assignee: RIZOMA S.R.L., Ferno (VA) (IT)

(21) Appl. No.: 19/245,795

(22) Filed: Jun. 23, 2025

(30) Foreign Application Priority Data
Apr. 10, 2025 (IT) 102025000007854

(51) Int. Cl. B62J 29/00

(52) U.S. Cl. CPC B62J 29/00

(57) ABSTRACT

A rear-view mirror for motorcycles, such as for motorbikes, including a support rod, a rear-view body mounted in a sliding manner on the support rod and a locking element for fixing the rear-view body at a given position along the support rod. The support rod includes, on its own side wall, a plurality of notches each defining a relative position between the support rod and the rear-view body and in that the locking element includes a nose shaped in such a way as to be insertable into a notch of the plurality of notches, where, with the nose inserted into a notch of the plurality of notches, the rear-view body is stably retained against translation with respect to the support rod.

### TECHNICAL FIELD

The present invention generally concerns an extendable rear-view mirror for motorcycles, preferably, but not exclusively, for two-wheeled vehicles, such as a motorbike, being however also suitable for use with particular three-wheeled vehicles, such as motor tricycles, or four-wheeled vehicles, such as quads.

### BACKGROUND

Nowadays, there are well-known types of rear-view mirrors for motorcycles that have the possibility of adjusting the position of the reflector with respect to the support rod in order to adapt the size of the mirror to the type of motorcycle on which it is mounted.

These rear-view mirrors are also particularly useful for switching between a use configuration, in which it is appropriate for the mirror to protrude more from the motorcycle, offering an increased field of vision, and a rest configuration, in which it is preferable for the mirror to have a reduced footprint, for example when the motorcycle is parked.

The known rear-view mirrors for motorcycles of the extendable type generally comprise a telescopic support rod which has the disadvantage of being bulky and aesthetically unpleasant. In addition, with time and wear, the telescopic support rod tends to spontaneously return to the maximum insertion position, making the total or intermediate extraction configurations unstable.

To offer a more linear design and greater reliability in use, rear-view mirrors have been made comprising a support rod on which a reflector and constraining means for fixing the reflector at a given position along the rod are mounted in a sliding manner. By way of example, mirrors are known in which in the support rod a slot is made developed parallel to the extension of the rod itself and means for constraining a rear-view mirror base to the rod, specifically as bolts, which engage the slot and the base, locking the latter against the rod.

Also in this case, time and wear can lead to a loosening of the constraining means and a consequent displacement of the rear-view mirror with respect to the rod. Moreover, this solution is not particularly practical if one often wants to switch from a compact configuration to an extended configuration and vice versa, as for this purpose it is necessary to operate through special tools, which are not always available.

### SUMMARY

In light of the foregoing, the task underlying the present invention is to obviate the problems of the prior art. Within this task, it is an object of the present invention to devise an extendable rear-view mirror for motorcycles that can be easily brought from a compact configuration to an extended configuration and vice versa without the aid of special tools. Another object of the present invention is to make an extendable rear-view mirror for motorcycles that is capable of maintaining the set configuration in a stable and durable manner over time.

Yet another object of the present invention is to make an extendable rear-view mirror for motorcycles that can be made in a simple and cost-effective way.

Not least object of the present invention is to conceive an extendable rear-view mirror for motorcycles that presents a pleasant aesthetics.

In accordance with a first aspect thereof, the invention therefore concerns an extendable rear-view mirror for motorcycles comprising a support rod, a rear-view body mounted in a sliding manner on the support rod and a locking element for fixing the rear-view body at a given position along the support rod.

According to the present invention the support rod comprises, on its own side wall, a plurality of notches each defining a relative position between the support rod and the rear-view body.

Furthermore, the locking element comprises a nose shaped in such a way as to be insertable into a notch of the plurality of notches, wherein, with the nose inserted into a notch of the plurality of notches, the rear-view body is stably retained against a translation with respect to the support rod.

The Applicant has thus realized an extendable rear-view mirror for motorcycles whose configuration can be easily modified simply by removing, at least temporarily, the engagement between the nose and the notch.

This solution also allows to switch easily between a compact configuration and an extended configuration without the aid of special tools.

On the contrary, when the nose is inserted into a notch of the support rod, the set configuration is maintained in a stable and durable way over time.

In accordance with a second aspect thereof, the invention concerns a motorcycle, in particular a motorbike, comprising a handlebar to which at least one extendable rear-view mirror for motorcycles as described above is attached.

Advantageously, the motorcycle thus configured allows to achieve the same advantages described with reference to the rear-view mirror for motorcycles according to the invention.

Further features of the preferred embodiments of the extendable rear-view mirror for motorcycles according to the present invention are the subject of the dependent claims.

In particular, according to a variant of the invention, the locking element can be constrained to the rear-view mirror body in a tilting manner between an engaging position, in which the nose engages a notch of the plurality of notches, and a release position, in which the nose is in a position away from the support rod and does not engage any notch of the plurality of notches.

Preferably, the locking element is directly or indirectly pivoted to the rear-view mirror body. Furthermore, between the locking element and the rear-view mirror body acting elastic means which force the locking element into the engaging position.

In a variant of the invention, the rear-view mirror body comprises a half-shell, wherein a window is obtained in a wall of the half-shell, inside the window there being positioned the locking element so that the nose is positioned at a portion of the side wall of the support rod on which the plurality of notches is obtained.

Advantageously, this allows the user to easily access the locking element to be able to operate it and then release the engagement between the nose and the corresponding notch.

Preferably, an insert positioned at the window is provided. The locking element is pivoted to the insert and the elastic means act between the locking element and the insert.

In a variant of the invention, the rear-view mirror body comprises a half-shell which integrates within it a longitudinally developed housing seat configured to slidably house one end of the support rod between a position of greater insertion and a position of lesser insertion.

Advantageously, the seat made internally to the half-shell prevents the accumulation of dirt at the rod, thus ensuring that it is always easy to slide the rear-view mirror body along the rod without the risk of blockages or snaps.

Preferably, the housing seat comprises a sliding slot which extend along the longitudinal development of the housing seat. A pin constrained to the support rod engages the slot.

Advantageously, this arrangement allows the sliding of the rear-view mirror body along the support rod to be guided in a stable manner.

Preferably, the support rod comprises a head element axially constrained to the support rod at the end housed inside the housing seat and configured to act as an endstop both with reference to a position of maximum extraction of the support rod from the housing seat, and with reference to a position of maximum insertion of the support rod into the housing seat. The head element is preferably made of elastic material to act as a shock absorber.

Preferably, the support rod comprises on its side wall a longitudinal groove which follows the development of the support rod and in which it engages a guide element for the sliding of the support rod inside the housing seat, such as for example the constraining means between a reflector element mounted in the half-shell and the half-shell itself.

Advantageously, in this way the sliding of the rear-view mirror body along the support rod is even more stably guided.

Preferably, the constraining means between the reflector element and the half-shell are such as to allow an orientation of the reflector element with respect to the half-shell with respect to at least one axis of rotation.

### BRIEF DESCRIPTION OF THE DRAWINGS

Further characteristics and advantages of the present invention will be more evident from the following description of some preferred embodiments thereof made with reference to the appended drawings.

The different characteristics in the individual configurations can be combined with each other at will according to the previous description, if the advantages resulting specifically from a particular combination were to be used.

In such drawings,

FIG. 1 is a front view of an extendable rear-view mirror for motorcycles according to a preferred embodiment of the present invention;

FIG. 2 is a rear view of the extendable rear-view mirror for motorcycles of FIG. 1;

FIG. 3 is a first exploded perspective view of the extendable rear-view mirror for motorcycles of FIG. 1 without reflective element;

FIG. 4 is a second exploded perspective view of the extendable rear-view mirror for motorcycles of FIG. 1 without reflective element;

FIG. 5 is a sectional view of the extendable rear-view mirror for motorcycles of FIG. 1 without a reflective element in the compact configuration;

FIG. 6 is a sectional view of the extendable rear-view mirror for motorcycles of FIG. 1 without a reflective element in the maximum extension configuration;

FIG. 7 is a rear perspective view of the extendable rear-view mirror for motorcycles of FIG. 1 in the compact configuration;

FIG. 8 is a rear perspective view of the extendable rear-view mirror for motorcycles of FIG. 1 in the maximum extension configuration;

FIG. 9A is a perspective view of a motorbike on which an extendable rear-view mirror is mounted according to a preferred embodiment of the present invention; and

FIG. 9B is an enlargement of the rear-view mirror of FIG. 9A.

### DETAILED DESCRIPTION OF THE EMBODIMENTS

For the illustration of the drawings, use is made in the following description of identical numerals or symbols to indicate construction elements with the same function. Moreover, for clarity of illustration, certain references may not be repeated in all drawings.

While the invention is susceptible to various modifications and alternative constructions, certain preferred embodiments are shown in the drawings and are described hereinbelow in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The use of “for example”, “etc.”, “or” indicates non-exclusive alternatives without limitation unless otherwise indicated. The use of “comprises” and “includes” means “comprises or includes, but not limited to”, unless otherwise indicated.

With reference to the attached figures, a preferred embodiment of an extendable rear-view mirror for motorcycles according to the present invention is illustrated, overall indicated with 10.

The extendable rear-view mirror 10 comprises a support rod 11 and a rear-view mirror body 20. The rear-view mirror body 20 is mounted in a sliding manner on the support rod 11.

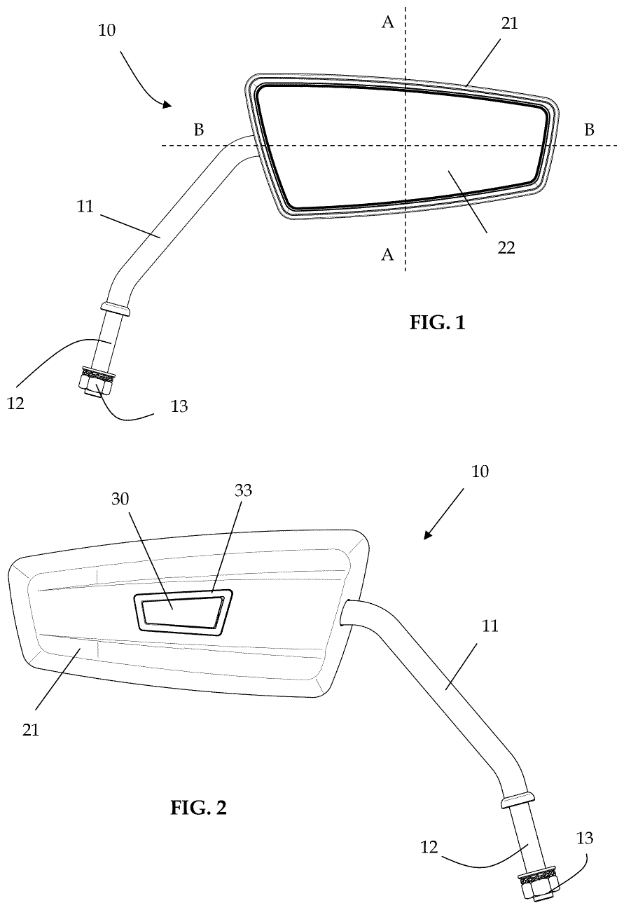

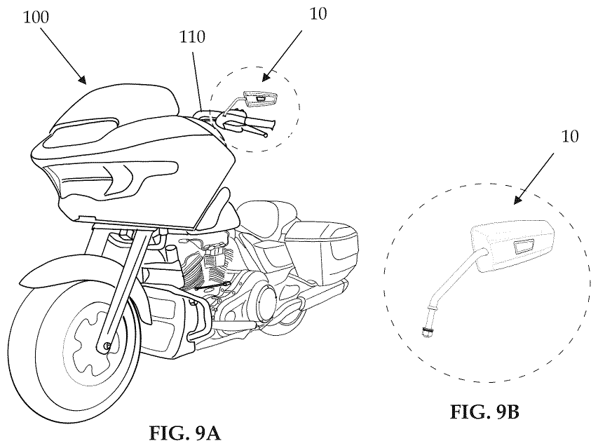

The support rod 11 comprises an interface portion 12 configured to be fixedly connected to a motorcycle 100, for example to a handlebar 110 of the motorcycle 100, as illustrated in FIG. 9. FIGS. 1 and 2 also show, by way of non-limiting example, constraining means 13 for connecting the rod 11 to the motorcycle which are connected to the interface portion 12.

The rear-view mirror body 20 comprises a half-shell 21 in which a reflective element 22 is mounted. In particular, the reflective element 22 can be mounted in the half-shell 21 in an orientable manner with respect to a first axis A and/or with respect to a second axis B, shown schematically in FIG. 1.

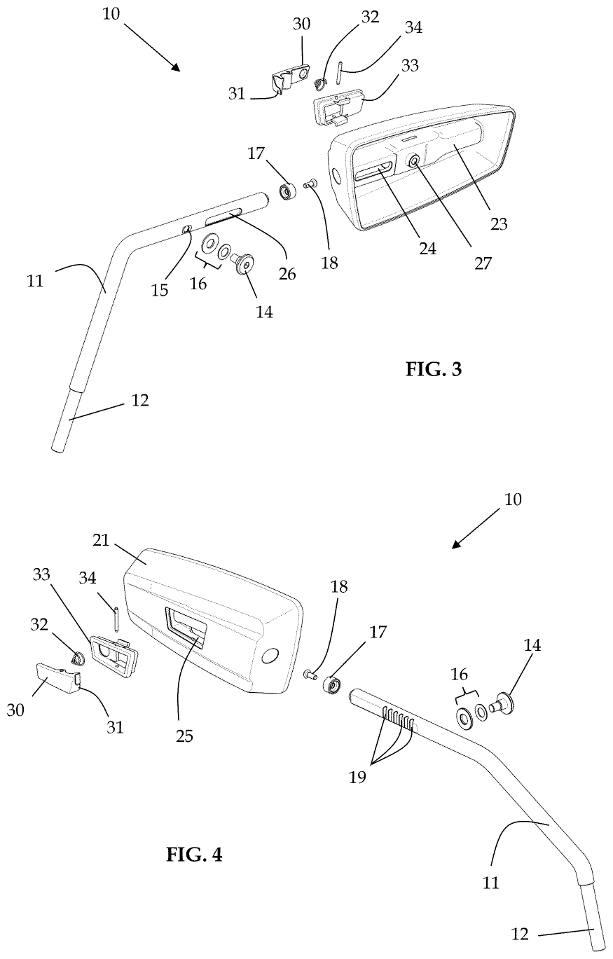

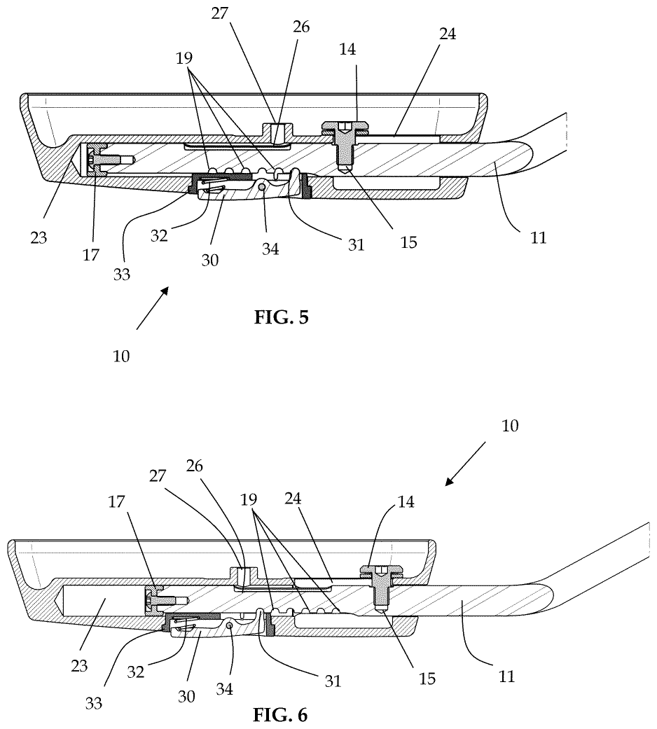

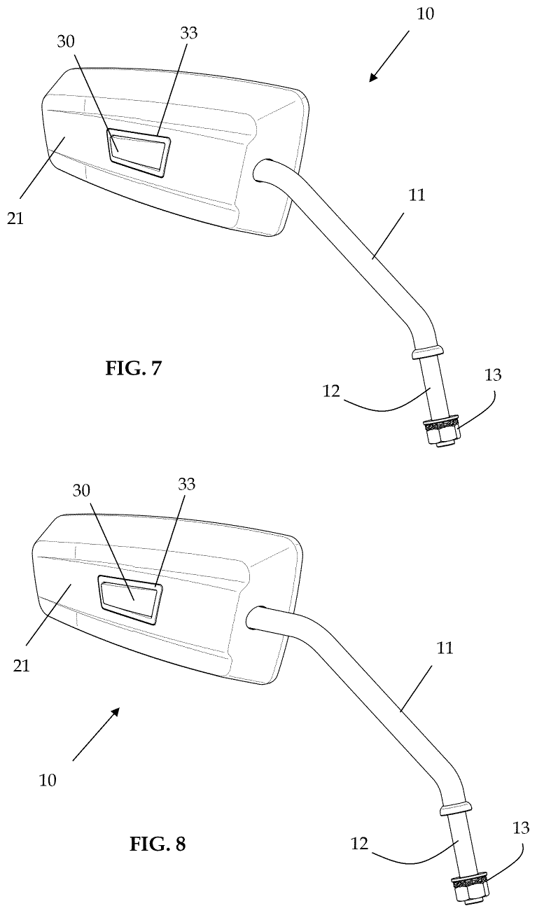

As shown in FIG. 3, the half-shell 21 integrates a longitudinally developed housing seat 23 configured to slidably house one end of the support rod 11 between a position of greater insertion, shown in FIGS. 5 and 7, and a position of lesser insertion, shown in FIGS. 6 and 8.

The housing seat 23 comprises a sliding slot 24 that extends along the longitudinal development of the seat 23, for a section of a side wall thereof 23. Preferably, the sliding slot 24 extends in a wall of the seat 23 turned towards the volume delineated internally to the half-shell 21.

A pin 14 constrained to the support rod 11 engages in the slot 24. In the illustrated embodiment, the pin 14 is made as a screw constrained to a hole 15 present on the support rod 11, preferably by interposing one or more washers 16.

The support rod 11 also preferably comprises a head element 17 axially constrained to the rod 11 at its end housed in the seat 23, for example by means of a screw 18. The head element 17 is preferably made of elastic material to act as an endstop shock absorber, both with reference to a position of maximum extraction of the rod 11 from the seat 23, and with reference to a position of maximum insertion of the rod 11 into the seat 23. In the position of maximum insertion of the rod 11 into the seat 23, the head element 17 abuts against a bottom of the seat 23 (FIG. 5). In the position of maximum extraction of the rod 11 from the seat 23, the head element 17 abuts against a protrusion made in the side wall of the seat 23 (FIG. 6).

The extendable rear-view mirror 10 further comprises a locking element 30 for fixing the rear-view body 20 at a given position along the support rod 11.

To this end, the support rod 11 comprises on its own side wall a plurality of notches 19 each defining a relative position of the rod 11 within the seat 23. The plurality of notches 19 is made on a rod portion 11 housed in the seat 23.

The notches 19 are configured to be engaged by a nose 31 made on the locking element 30 shaped in such a way as to be able to be inserted into a notch 19 of the plurality of notches. To this end, the plurality of notches 19 is made on a portion of the rod 11 turned towards the locking element 30.

With the nose 31 inserted in a notch 19, the support rod 11 is stably retained against axial translation along the development of the seat 23 in which the rod 11 is housed.

The locking element 30 is positioned at a window 25 made in a wall of the half-shell 21 in such a way that the nose 31 can come into contact with the portion of the rod 11 on which the plurality of notches 19 is made. In other words, the window 25 made on the half-shell 21 faces internally to the seat 23 and the plurality of notches 19 is made on a rod portion 11 turned towards the window 25.

The locking element 30 is constrained to the half-shell 21 in a tilting manner between an engaging position, in which the nose 31 engages a notch of the plurality of notches 19, and a release position, in which the nose 31 is in a position away from the rod 11 and does not engage any notch of the plurality of notches 19.

To this end, an insert 33 coupled to the window 25 is preferably provided, for example by interlocking, to which the locking element 30 is pivoted at a substantially central portion thereof, for example through a peg 34. The insert 33 is preferably coupled to the window 25 in such a way as to protrude towards the inside of the seat 23 and, in this way, implement the protrusion against which the head element 17 abuts when the rod 11 is in the position of maximum extraction from the seat 23.

Elastic means 32 act between the locking element 30 and the insert 33, forcing the locking element 30 into the engaging position, with the nose 31 engaging a notch 19.

Since the locking element 30 is placed at the window 25 made in the wall of the half-shell 21, it is easily accessible by a user in order to exert a counteracting force to the force exerted by the elastic means 32 and, in this way, disengage the nose 31 from the notch 19. With the locking element 30 disengaged from the rod 11, the half-shell 21 that integrates the seat 23 is free to slide along the rod 11, thus modifying the degree of insertion of the rod 11 into the seat 23, to be positioned in the desired configuration. Once the desired configuration has been reached, it is possible to lock the rear-view mirror body 20 in place simply by releasing the locking element 30 so that the nose 31 engages with a new notch 19.

The support rod 11 further comprises on its side wall a longitudinal groove 26 which follows the development of the rod 11. Although not illustrated, in the groove 26 constraining means engage between the reflector element 22 and the half-shell 21, thus guiding the sliding of the rod 11 inside the seat 23. The constraining means engage the groove 26 passing through a hole 27 made in the wall of the seat 23 turned towards the volume delineated internally to the half-shell 21.

FIG. 9A shows a motorbike on which an extendable rear-view mirror 10 for motorcycles according to the present invention is fixedly mounted. In particular, the extendable rear-view mirror 10, illustrated in enlarged form in FIG. 9B, is constrained to a handlebar 110 of the motorbike 100.

1. A rear-view mirror for motorcycles, comprising:
a support rod,
a rear-view body mounted in a sliding manner on the support rod, and
a locking element for fixing the rear-view body at a given position along the support rod, wherein the support rod comprises, on its own side wall, a plurality of notches each defining a relative position between the support rod and the rear-view body and the locking element comprises a nose shaped in such a way as to be insertable into a notch of the plurality of notches, wherein, with the nose inserted into a notch of the plurality of notches, the rear-view body is stably retained against translation with respect to the support rod.

2. The rear-view mirror according to claim 1, wherein the locking element is constrained to the rear-view body in a tilting manner between an engaging position, in which the nose engages a notch of the plurality of notches, and a release position, in which the nose is in a position away from the support rod and does not engage any notch of the plurality of notches.

3. The rear-view mirror according to claim 2, wherein the locking element is directly or indirectly pivoted to the rear-view body, between the locking element and the rear-view body acting elastic means which force the locking element into the engaging position.

4. The rear-view mirror according to claim 1, wherein the rear-view body comprises a half-shell, and wherein a window is obtained in a wall of the half-shell, inside the window there being positioned the locking element so that the nose is positioned at a portion of the side wall of the support rod on which the plurality of notches is obtained.

5. The rear-view mirror according to claim 4, further comprising an insert positioned at the window, the locking element being hinged to the insert and the elastic means acting between the locking element and the insert

6. The rear-view mirror according to claim 1, wherein the rear-view body comprises a half-shell which integrates within it a longitudinally developed housing seat configured to slidably house one end of the support rod between a position of greater insertion and a position of lesser insertion.

7. The rear-view mirror according to claim 6, wherein the housing seat comprises a sliding slot which extends along the longitudinal development of the housing seat, wherein a pin constrained to the support rod engages the slot.

8. The rear-view mirror according to claim 7, wherein the support rod comprises a head element axially constrained to the support rod at the end housed inside the housing seat and configured to act as an endstop both with reference to a position of maximum extraction of the support rod from the housing seat, and with reference to a position of maximum insertion of the support rod into the housing seat wherein the head element made of elastic material to act as a shock absorber.

9. The rear-view mirror according to claim 8, wherein the support rod comprises on its side wall a longitudinal groove which follows the development of the support rod and in which it engages a guide element for the sliding of the support rod inside the housing seat.

10. A motorcycle comprising: a handlebar to which at least one rear-view mirror for motorcycles according to claim 1 is attached.
